(19) United States
(12) Patent Application Publication
(10) Pub. No.: US 2025/0389968 A1
(43) Pub. Date: Dec. 25, 2025

(54) DISPLAY DEVICE AND ELECTRONIC DEVICE INCLUDING THE SAME

(71) Applicant: Samsung Display Co., LTD., Yongin-si (KR)

(72) Inventors: Jun Bo SIM, Yongin-si (KR); Jun Youn KIM, Yongin-si (KR); Joo Woan CHO, Yongin-si (KR)

(73) Assignee: Samsung Display Co., LTD., Yongin-si (KR)

(21) Appl. No.: 19/219,016

(22) Filed: May 27, 2025

(30) Foreign Application Priority Data
Jun. 20, 2024 (KR) 10-2024-0080051
Sep. 6, 2024 (KR) 10-2024-0121715

(51) Int. Cl. G02B 27/14

(52) U.S. Cl. CPC G02B 27/141

(57) ABSTRACT

Provided is a display device including a first to third display panels that emit light of different colors, first to third optical lenses arranged on each of the first to third display panels to collimate the first to third lights into first to third collimated lights, a first dichroic mirror that reflects the first collimated light as first reflected light, a second dichroic mirror that transmits the first reflected light as (1_1)st transmitted light and reflects the second collimated light as second reflected light, and a third dichroic mirror that transmits the (1_1)st transmitted light as (1_2)nd transmitted light, transmits the second reflected light as second transmitted light, and reflects the third collimated light as third reflected light.

### CROSS-REFERENCE TO RELATED APPLICATION(S)

This application claims priority to and benefits of Korean Patent Application No. 10-2024-0080051 under 35 U.S.C. § 119, filed on Jun. 20, 2024, and Korean Patent Application No. 10-2024-0121715 under 35 U.S.C. § 119, filed on Sep. 6, 2024, in the Korean Intellectual Property Office, the entire contents of which are incorporated herein by references.

### BACKGROUND

### 1. Technical Field

The disclosure generally relates to a display device, and an electronic device including the same.

### 2. Description of the Related Art

Display devices have become an important element of modern electronic devices as they permit the effective and intuitive display of information to a user.

### SUMMARY

Embodiments of the disclosure provide a display device in which heat generation and degradation of the display device can be reduced or prevented, and the weight and volume of the display device can be decreased.

A display device includes a first display panel emitting first light, a second display panel emitting second light having a color different from a color of the first light, a third display panel emitting third light having a color different from the colors of the first and second lights, a first optical lens disposed on the first display panel to collimate the first light into first collimated light, a second optical lens disposed on the second display panel to collimate the second light into second collimated light, a third optical lens disposed on the third display panel to collimate the third light into third collimated light, a first dichroic mirror disposed on an optical path of the first collimated light, to reflect the first collimated light as first reflected light, a second dichroic mirror disposed on the optical path of the first collimated light and an optical path of the second collimated light, to allow the first reflected light to be transmitted as (1_1)st transmitted light therethrough and reflect the second collimated light as second reflected light, and a third dichroic mirror disposed on the optical path of the (1_1)st transmitted light, an optical path of the second reflected light, and an optical path of the third collimated light, to allow the (1_1)st transmitted light to be transmitted as (1_2)nd transmitted light therethrough, allow the second reflected light to be transmitted as second transmitted light therethrough, and reflect the third collimated light as third reflected light.

The first to third display panels may substantially extend in a same direction.

The first light may be emitted in a first emission direction from the first display panel, the second light may be emitted in a second emission direction from the second display panel, and the third light may be emitted in a third emission direction from the third display panel. The first to third emission directions may be substantially a same direction.

The first light may be emitted through a first emission path from the first display panel, the second light may be emitted through a second emission path from the second display panel, and the third light may be emitted through a third emission path from the third display panel. The first to third emission paths may be parallel to one another.

The (1_2)nd transmitted light, the second transmitted light, and the third reflected light may be combined as output light to be viewed by a user. A fourth emission path of the output light may intersect each of the first to third emission paths.

Each of the first to third optical lenses may be a meta-lens.

The display device may further include: a first circuit portion on which the first display panel is disposed, a second circuit portion on which the second display panel is disposed, and a third circuit portion on which the third display panel is disposed. The first to third circuit portions may substantially extend in a same direction.

A first thickness of the first circuit portion, a second thickness of the second circuit portion, and a third thickness of the third circuit portion may be different from one another.

The first thickness may be thicker than the second thickness, and the second thickness may be thicker than the third thickness.

The display device may further include: a first circuit board layer overlapping the first to third circuit portions, a second circuit board layer overlapping the first and second circuit portions, and a third circuit board layer overlapping the first circuit portion.

The first circuit board layer, the second circuit board layer, and the third circuit board layer may be sequentially stacked.

The second circuit board layer may be exposed without being covered by the third circuit board layer in the second circuit portion. The first circuit board layer may be exposed without being covered by the second and third circuit bord layers in the third circuit portion.

The first circuit board layer may overlap the third display panel in an area in which the first circuit board layer is exposed without being covered by the second and third circuit board layers. The second circuit board layer may overlap the second display panel in an area in which the second circuit board layer is exposed without being covered by the third circuit board layer.

The first display panel may be disposed on the third circuit board layer, the second display panel may be disposed on the second circuit board layer, and the third display panel may be disposed on the first circuit board layer.

The first circuit board layer may include a first base layer, a first conductive layer which is disposed on the first base layer and includes a plurality of first conductive lines electrically connected to the third display panel, and a first insulating layer disposed on the first conductive layer. The second circuit board layer may include a second base layer disposed on the first insulating layer, a second conductive layer which is disposed on the second base layer and includes a plurality of second conductive lines electrically connected to the second display panel, and a second insulating layer disposed on the second conductive layer. The third circuit board layer may include a third base layer disposed on the second insulating layer, a third conductive layer which is disposed on the third base layer and includes a plurality of third conductive lines electrically connected to the first display panel, and a third insulating layer disposed on the third conductive layer.

The first display panel may include a first pad portion electrically connected to the plurality of third conductive lines. The second display panel may include a second pad portion electrically connected to the plurality of second conductive lines. The third display panel may include a third pad portion electrically connected to the plurality of first conductive lines.

The first circuit portion may include a first circuit pad portion electrically connected to the plurality of third conductive lines, the second circuit portion may include a second circuit pad portion electrically connected to the plurality of second conductive lines, and the third circuit portion may include a third circuit pad portion electrically connected to the plurality of first conductive lines.

The display device may further include a fourth circuit portion extending from any one of the first to third circuit portions, the fourth circuit portion not overlapping the first to third display panels.

The fourth circuit portion may include: a first via hole sequentially penetrating the third insulating layer, the third conductive layer, the third base layer, the second insulating layer, the second conductive layer, the second base layer, and the first insulating layer, a second via hole sequentially penetrating the third insulating layer, the third conductive layer, and the third base layer, and the second insulating layer, and a third via hole penetrating the third insulating layer.

An electronic device may include a processor, and a display device including pixels, and configured to display images on the pixels under control of the processor. The display device may include: a first display panel emitting first light; a second display panel emitting second light having a color different from a color of the first light; a third display panel emitting third light having a color different from the colors of the first and second lights; a first optical lens disposed on the first display panel to collimate the first light into first collimated light; a second optical lens disposed on the second display panel to collimate the second light into second collimated light; a third optical lens disposed on the third display panel to collimate the third light into third collimated light; a first dichroic mirror disposed on an optical path of the first collimated light, to reflect the first collimated light as first reflected light; a second dichroic mirror disposed on the optical path of the first collimated light and an optical path of the second collimated light, to allow the first reflected light to be transmitted as (1_1)st transmitted light therethrough and reflect the second collimated light as second reflected light; and a third dichroic mirror disposed on the optical path of the (1_1)st transmitted light, an optical path of the second reflected light, and an optical path of the third collimated light, to allow the (1_1)st transmitted light to be transmitted as (1_2)nd transmitted light therethrough, allow the second reflected light to be transmitted as second transmitted light therethrough, and reflect the third collimated light as third reflected light.

### BRIEF DESCRIPTION OF THE DRAWINGS

The above and other features of the disclosure will become more apparent by describing in further detail embodiments thereof with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may be present. Like reference numerals refer to like elements throughout.

FIG. 1 is a schematic perspective view illustrating a display device according to an embodiment of the disclosure.

FIG. 2 is a schematic side view illustrating a portion of the display device shown in FIG. 1.

FIG. 3 is a schematic plan view illustrating a portion of the display device shown in FIG. 1.

FIG. 4 is a schematic cross-sectional view illustrating an embodiment taken along line I-I′ shown in FIG. 3.

FIG. 5 is an enlarged schematic plan view illustrating area A shown in FIG. 3.

FIG. 6 is a schematic cross-sectional view illustrating an embodiment taken along line II-II′ shown in FIG. 5.

FIG. 7 is an enlarged schematic plan view illustrating area B1 shown in FIG. 3.

FIG. 8 is an enlarged schematic plan view illustrating area C shown in FIG. 7.

FIG. 9 is a schematic cross-sectional view illustrating an embodiment taken along line S-S′ shown in FIG. 8.

FIG. 10 is a schematic cross-sectional view illustrating an embodiment taken along line P-P′ shown in FIG. 3.

FIG. 11 is a schematic cross-sectional view illustrating an embodiment taken along line Q-Q′ shown in FIG. 3.

FIG. 12 is a schematic cross-sectional view illustrating an embodiment taken along line R-R′ shown in FIG. 3.

FIG. 13 is a schematic cross-sectional view illustrating an embodiment taken along line III-III′ shown in FIG. 3.

FIG. 14 is a schematic cross-sectional view illustrating an embodiment taken along line IV-IV′ shown in FIG. 3.

FIG. 15 is a schematic cross-sectional view illustrating an embodiment taken along line V-V′ shown in FIG. 3.

FIG. 16 is a schematic cross-sectional view illustrating a light emitting element of an embodiment of the disclosure.

FIG. 17 is a schematic diagram of an equivalent circuit of a pixel of an embodiment of the disclosure.

FIG. 18 is a schematic block diagram illustrating a display system according to an embodiment of the disclosure.

FIG. 19 is a schematic perspective view illustrating an embodiment of smart glasses including the display device shown in FIG. 1.

### DETAILED DESCRIPTION OF THE EMBODIMENT

Hereinafter, embodiments of the disclosure are described in more detail with reference to the accompanying drawings. In the description below, only a necessary part to understand an operation according to the disclosure is described and the descriptions of other parts are omitted in order not to unnecessarily obscure subject matters of the disclosure. The disclosure is not limited to example embodiments described herein, but may be embodied in various different forms. Rather, example embodiments described herein are provided to thoroughly and completely describe the disclosed contents and to sufficiently transfer the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not necessarily intended to limit other embodiments of the disclosure. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms may be only used to distinguish one element from another element. Thus, a “first” element discussed below could be termed a “second” element without departing from the teachings of the disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the example term, “above,” may encompass both an orientation of above and below. The apparatus may be otherwise oriented (e.g., rotated 90 degrees or at other orientations) and the spatially relative descriptors used herein interpreted accordingly.

The embodiments of the disclosure are described here with reference to schematic diagrams of ideal embodiments (and an intermediate structure) of the disclosure, so that changes in a shape as shown due to, for example, manufacturing technology and/or a tolerance may be expected. Therefore, the embodiments of the disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

Hereinafter, example embodiments of the disclosure will be described in detail with reference to the accompanying drawings.

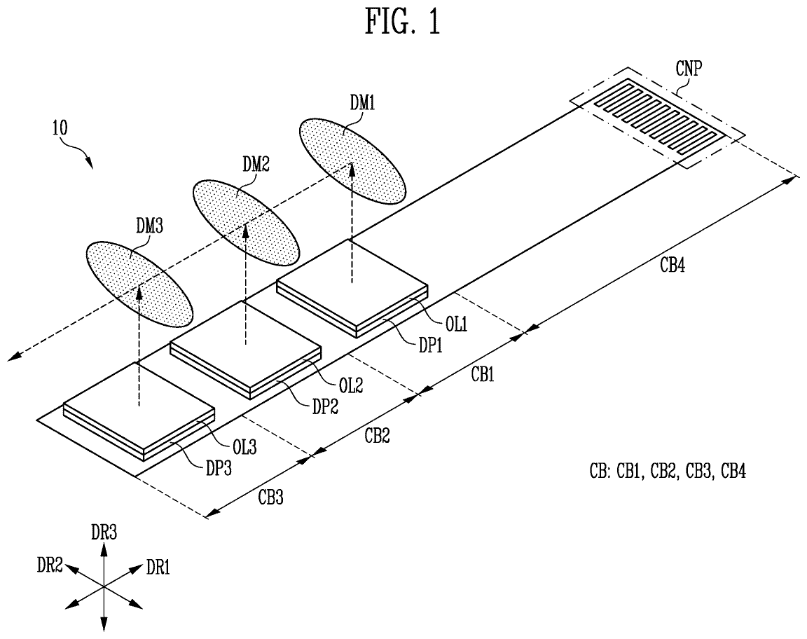

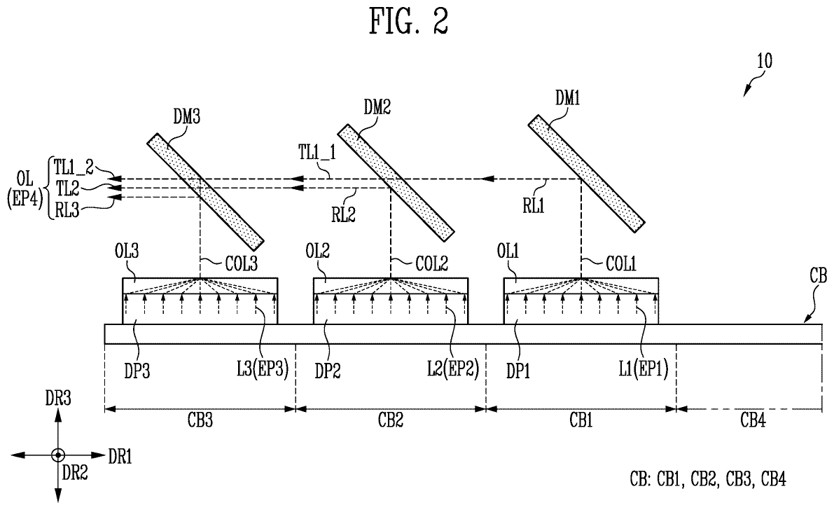

FIG. 1 is a schematic perspective view illustrating a display device of an embodiment of the disclosure. FIG. 2 is a schematic side view illustrating a portion of the display device shown in FIG. 1.

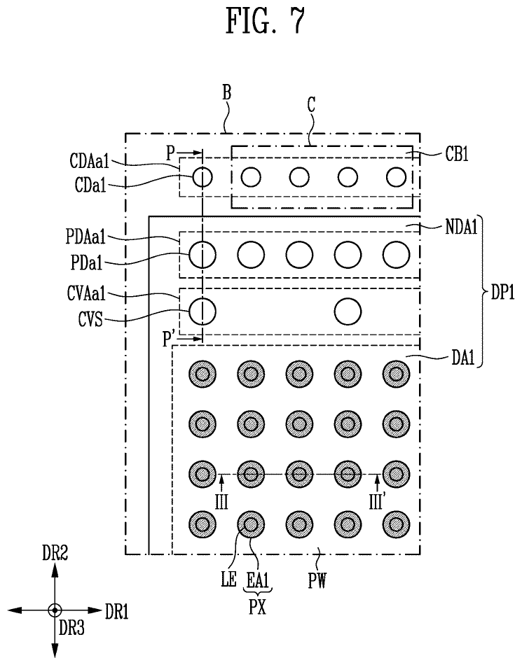

As depicted in FIG. 1, it is described that the embodiment of the display device 10 is a subminiature light emitting diode display device (i.e., a micro or nano light emitting diode display device) including a subminiature light emitting diode (i.e., a micro or nano light emitting diode) as a light emitting element (see LE shown in FIG. 7). However, embodiments are not limited thereto.

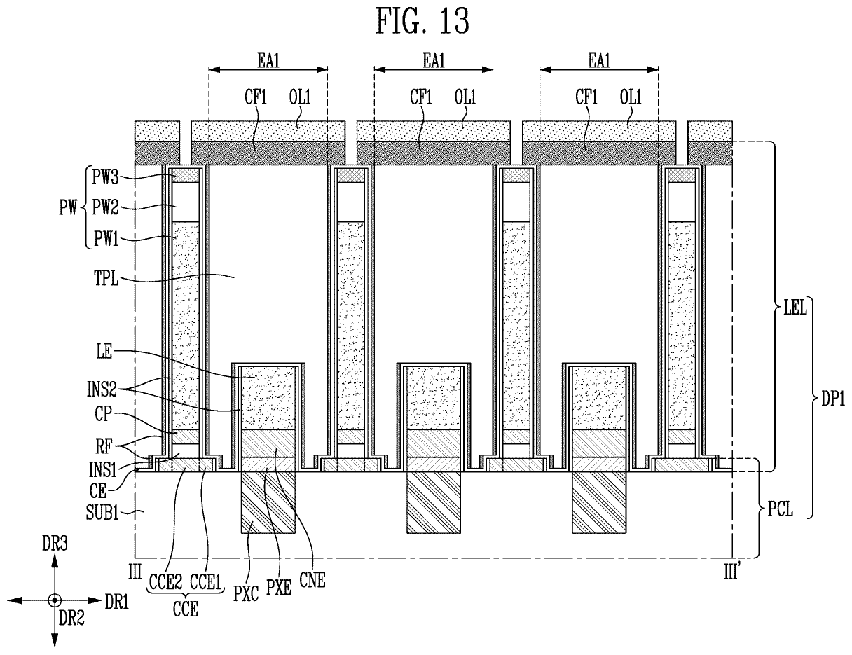

As depicted in FIG. 1, it is described that the embodiment of the display device 10 is a light emitting diode on silicon (LEDos) in which light emitting diodes are disposed as the light emitting element LE on a pixel circuit layer (see PCL shown in FIGS. 13 to 15) formed through a semiconductor process using a silicon wafer. However, embodiments are not limited thereto.

as depicted in FIG. 1, a first direction DR1 may mean a lateral direction of first to third display panels DP1 to DP3, a second direction DR2 may mean a longitudinal direction of the first to third display panels DP1 to DP3, and a third direction DR3 may mean a thickness direction of the first to third display panels DP1 to DP3. “Left,” “right,” “top,” and “bottom” may mean directions in case that the first to third display panels DP1 to DP3 are viewed on a plane. For example, a “right side” may mean one side of the first direction DR1, a “left side” may mean the other side of the first direction DR1, a “top side” may mean one side of the second direction DR2, and a “bottom side” may mean the other side of the second direction DR2. A “top portion” may mean one side of the third direction DR3, and a “bottom portion” may mean the other side of the third direction DR3.

Referring to FIGS. 1 and 2, a display device 10 in accordance with an embodiment of the disclosure may include a first display panel DP1, a second display panel DP2, a third display panel DP3, a first optical lens OL1, a second optical lens OL2, a third optical lens OL3, a first dichroic mirror DM1, a second dichroic mirror DM2, and a third dichroic mirror DM3. For example, the first optical lens OL1 may be disposed on the first display panel DP1, the second optical lens OL2 may be disposed on the second display panel DP2, and the third optical lens OL3 may be disposed on the third display panel DP3 in the third direction DR3. Each of a first dichroic mirror DM1, a second dichroic mirror DM2, and a third dichroic mirror DM3 may be disposed on and spaced apart from each of the first optical lens OL1, the second optical lens OL2, the third optical lens OL3 in the third direction DR3.

Each of the first to third display panels DP1 to DP3 may have a quadrangular planar shape in a plan view, but embodiments are not limited thereto. For example, each of the first to third display panels DP1 to DP3 may have a polygonal, circular, elliptical or atypical planar shape in a plan view.

Each of the first to third display panels DP1 to DP3 may emit monochromatic light.

The first display panel DP1 may emit first light L1. The first light L1 may be light in a blue wavelength band. The first light L1 may be light having a wavelength band of about 370 nm to about 460 nm, but embodiments are not limited thereto.

The second display panel DP2 may emit second light L2 different from the first light L1. The second light L2 may be light in a green wavelength band. The second light L2 may be light having a wavelength band of about 480 nm to about 560 nm, but embodiments are not limited thereto.

The third display panel DP3 may emit third light L3 different from the first and second lights L1 and L2. The third light L3 may be light in a red wavelength band. The third light L3 may be light having a wavelength band of about 600 nm to about 750 nm, but embodiments are not limited thereto.

The first display panel DP1 may be disposed on a plane formed by the first and second directions DR1 and DR2. Like the first display panel DP1, the second display panel DP2 may be disposed on the plane formed by the first and second directions DR1 and DR2. Like the first and second display panels DP1 and DP2, the third display panel DP3 may be disposed on the plane formed by the first and second directions DR1 and DR2. In other embodiments, the first to third display panels DP1 to DP3 may substantially extend in the same direction. The first to third display panels DP1 to DP3 may extend in the first and second directions DR1 and DR2.

According to above-described arrangement structure of the first to third display panels DP1 to DP3, the first to third lights L1 to L3 may be substantially emitted in the same direction. The first light L1 may be emitted in a first emission direction from the first display panel DP1. The second light L2 may be emitted in a second emission direction from the second display panel DP2. The third light L3 may be emitted in a third emission direction from the third display panel DP3. The first to third emission directions may be substantially the same direction. For example, the first to third emission directions may be the third direction DR3.

In another embodiment, the first light L1 may be emitted through a first emission path EP1 from the first display panel DP1. The second light L2 may be emitted through a second emission path EP2 from the second display panel DP2. The third light may be emitted through a third emission path EP3 from the third display panel DP3. The first to third emission paths EP1 to EP3 may be parallel to each other and spaced apart from each other in the first direction DR1.

The first optical lens OL1 may be disposed on the top of the first display panel DP1 to collimate the first light L1 into first collimated light COL1.

The second optical lens OL2 may be disposed on the top of the second display panel DP2 to collimate the second light L2 into second collimated light COL2.

The third optical lens OL3 may be disposed on the top of the third display panel DP3 to collimate the third light L3 into third collimated light COL3.

Each of the first to third optical lenses OL1 to OL3 may be a meta-lens.

The meta-lens is a plane lens having no curve, and may function to focus light on a specific point by arranging nanoparticles smaller than a wavelength of the light on a surface thereof. While the existing lenses adjusted an angle of light by allowing their surfaces to be convex or concave, the meta-lens may perform functions of a lens even in case that the meta-lens has a thin thickness which is at a level of a few micrometers.

The meta-lens may arrange meta atom having a nano size smaller than wavelengths of the first to third lights L1 to L3 on a meta surface in a constant cycle, thereby changing a direction of incident light such that the light advances toward a specific point. The “meta atom” means a structure manufactured to artificially have a specific property, using a geometric characteristic of a natural material, and the “meta surface” means a surface on which meta atoms are arranged in a constant cycle. The meta atom may representatively have nanorod and nanopillar shapes, and be manufactured using titanium dioxide (TiO₂), gallium nitride (GaN), ore the like, which is a nonmetallic dielectric. As such, in case that the first to third optical lenses OL1 to OL3 are the meta-lens, the existing convex and/or concave lenses which are heavy and bulky are not used, and hence each of the first to third lights L1 to L3 emitted from the first to third display panels DP1 to DP3 can be condensed and/or collimated while remarkably reducing the volume and weight of the display device 10.

The first dichroic mirror DM1 may be disposed on an optical path of the first collimated light COL1, to reflect the first collimated light COL1 as first reflected light RL1.

The second dichroic mirror DM2 may be disposed on an optical path of the first reflected light RL1 and an optical path of the second collimated light COL2, to allow the first reflected light RL1 to be transmitted as a (1_1)st transmitted light TL1_1 therethrough and reflect the second collimated light COL2 as second reflected light RL2.

The third dichroic mirror DM3 may be disposed on an optical path of the (1_1)st transmitted light TL1_1, an optical path of the second reflected light RL2, and an optical path of the third collimated light COL3, to allow the (1_1)st transmitted light TL1_1 to be transmitted as (1_2)nd transmitted light TL1_2 therethrough, allow the second reflected light RL2 to be transmitted as second transmitted light TL2 therethrough, and reflect the third collimated light COL3 as third reflected light RL3.

The first to third dichroic mirrors DM1 to DM3 may reflect light having a specific wavelength, and allow light having a wavelength different from the specific wavelength to be transmitted therethrough.

The first dichroic mirror DM1 may reflect, as the first reflected light RL1, the first collimated light COL1 having a blue wavelength band of about 370 nm to about 460 nm, and allow light having a wavelength band different from the blue wavelength band to be transmitted as it is therethrough. Since light having another wavelength band except the first collimated light COL1 having the blue wavelength band is not incident onto the first dichroic mirror DM1, only the first reflected light RL1 obtained by reflecting the first collimated light COL1 may be guided in a direction facing the second dichroic mirror DM2.

The second dichroic mirror DM2 may reflect, as the second reflected light RL2, the second collimated light COL2 having a green wavelength band of about 480 nm to about 560 nm, and allow the first reflected light RL1 having a wavelength band different from the green wavelength band to be transmitted as the (1_1)st transmitted light therethrough. Since the first reflected light RL1 incident onto the second dichroic mirror DM2 has the blue wavelength band, the first reflected light RL1 may be guided in a direction facing the third dichroic mirror DM3 while being transmitted through the second dichroic mirror DM2.

The third dichroic mirror DM3 may reflect, as the third reflected light RL3, the third collimated light COL3 having a red wavelength band of about 600 nm to about 750 nm, and allow the (1_1)st transmitted light TL1_1 and the second reflected light RL2, which have wavelength bands different from the red wavelength band, to be respectively transmitted as the (1_2)nd transmitted light TL1_2 and the second transmitted light TL2 therethrough. Since the (1_1)st transmitted light TL1_1 incident onto the third dichroic mirror DM3 has the blue wavelength band and the second reflected light RL2 has the green wavelength band, the (1_1)st transmitted light TL1_1 and the second reflected light RL2 may be continuously guided in the first direction DR1 while being transmitted through the third dichroic mirror DM3.

The (1_2)nd transmitted light TL1_2 and the second transmitted light TL2, which are transmitted through the third dichroic mirror DM3, and the third reflected light reflected from the third dichroic mirror DM3 may be combined as output light of the display device 10 to be viewed by a user. A fourth emission path EP4 of the output light OL may intersect the first to third emission paths EP1 to EP3 of the first to third lights L1 to L3 parallel to each other. For example, the fourth emission path EP4 of the output light OL may correspond to the first direction DR1 intersecting the third direction DR3 corresponding to the first to third emission paths EP1 to EP3, and the first direction DR1 may be set to a position at which the user can view the output light OL.

The display device 10 collimates, reflects, and/or condenses mono-color lights emitted from the first to third display panels DP1 to DP3 through the first to third optical lenses OL1 to OL3 and the first to third dichroic mirrors DM1 to DM3, thereby implementing a multi-color light display.

In order to generate output light which the user can view by condensing, reflecting, and/or collimating lights having different wavelengths, which are emitted from multiple display panels, a structure was conventionally used, in which display panels emitting lights having different wavelengths were disposed on side surfaces of a cube-shaped prism. However, in case that the structure is used, the structure is a structure in which the weight and volume of a display device is increased, and at least two display panels are to face each other. Therefore, heat generation and/or degradation occurred in a central portion of the prism due to a structural limitation that light having different wavelengths were condensed on one point inside the display device.

On the other hand, in the case of the display device 10 in accordance with the embodiments of the disclosure, the first to third display panels DP1 to DP3 are substantially disposed on the same plane so that the first to third emission paths EP1 to EP3 of the first to third lights L1 to L3 can be parallel to each other. Thus, condensation is not made inside the display device 10, thereby preventing heat generation and degradation of the display device 10.

The first to third optical lenses OL1 to OL3 and the first to third dichroic mirrors DM1 to DM3 may be disposed downstream of the first to third display panels DP1 to DP3 on the optical paths, so that a multi-color light display can be implemented without using any separate prism. Thus, the weight and volume of the display device 10 can be decreased.

The first to third display panels DP1 to DP3 may be disposed on a circuit board CB. The circuit board CB may be disposed on rear surfaces of the first to third display panels DP1 to DP3. The “rear surfaces” mean surfaces opposite to surfaces through the first to third display panels DP1 to DP3 emit the first to third lights L1 to L3. The circuit board CB may be attached to the rear surfaces of the first to third display panels DP1 to DP3 through any one of an adhesive sheet, a liquid adhesive agent, a pressure sensitive adhesive, and a double-sided tape, but embodiments are not limited thereto.

The circuit board CB may include a first circuit portion CB1, a second circuit portion CB2, a third circuit portion CB3, and a fourth circuit portion CB4.

The first display panel DP1 may be disposed on the first circuit portion CB1. The second display panel DP2 may be disposed on the second circuit portion CB2. The third display panel DP3 may be disposed on the third circuit portion CB3. As described above, the first to third display panel DP1 to DP3 may substantially extend in the same direction. Similarly, the first to third circuit portions CB1 to CP3 may substantially extend in the same direction. The first to third circuit portions CB1 to CB3 may extend in the first and second directions DR1 and DR2.

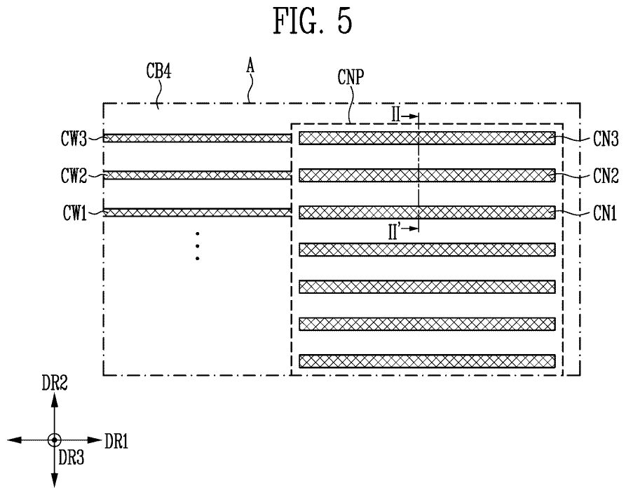

The fourth circuit portion CB4 may extend from any one of the first to third circuit portions CB1 to CB3, and may not overlap the first to third display panels DP1 to DP3. The fourth circuit portion CB4 may be an area electrically connected to an external connector (not shown). The fourth circuit portion CB4 may include a connector connection portion CNP electrically connected to the external connector. The connector connection portion CNP may provide a space in which the external connector and multiple conductive lines (CW1 to CW3 shown in FIG. 5) included in the circuit board CB are electrically connected to each other.

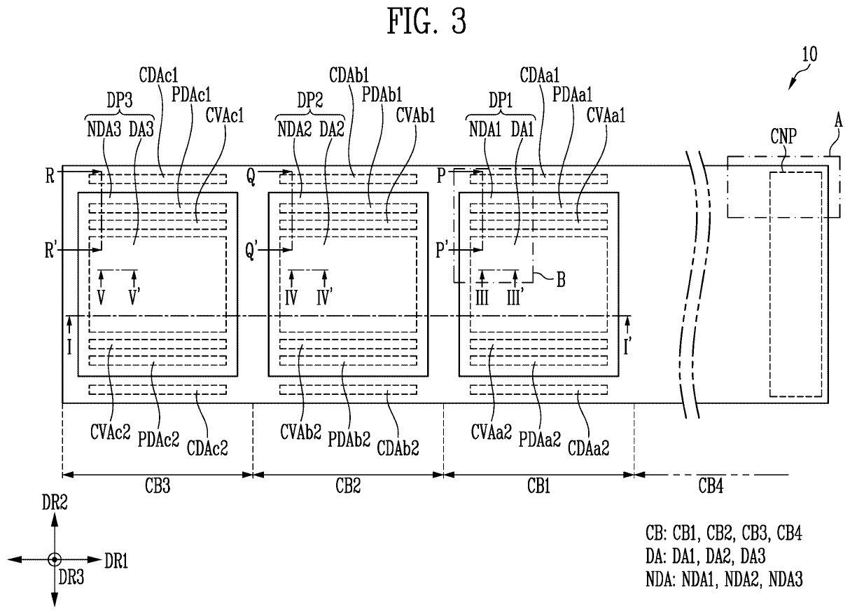

Hereinafter, the circuit board CB will be described in detail with reference to FIGS. 3 to 6.

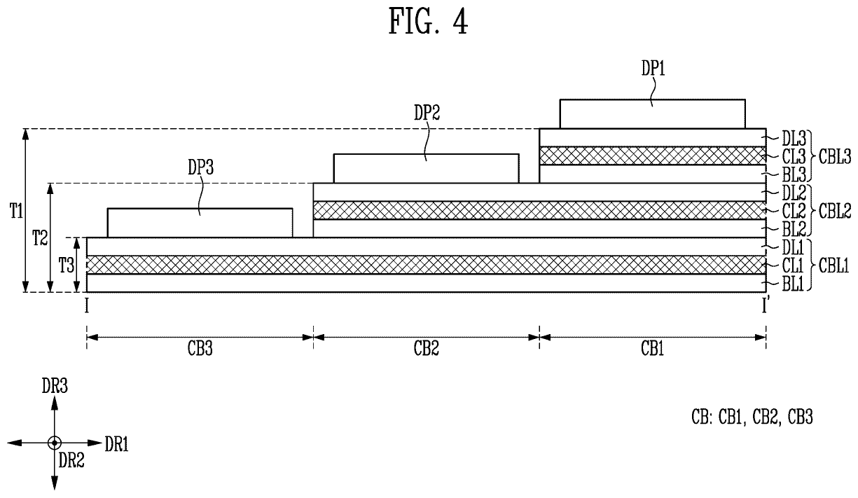

FIG. 3 is a schematic plan view illustrating a portion of the display device shown in FIG. 1. FIG. 4 is a schematic cross-sectional view illustrating an embodiment taken along line I-I′ shown in FIG. 3.

Referring to FIGS. 3 and 4, the first display panel DP1, the second display panel DP2, and the third display panel DP3 may be sequentially disposed in the first direction DR1 on the first circuit portion CB1, the second circuit portion CB2, and the third circuit portion CB3 of the circuit board CB. The first to fourth circuit portions CB1 to CB4 may form one circuit board CB.

The circuit board CB may be a flexible printed circuit board (FPCB), a printed circuit board (PCB), a flexible printed circuit (FPC), or a flexible film such as a chip on film (COF).

Each of the first to third display panels DP1 to DP3 may include a display area DA and a non-display area NDA.

The display area DA may be an area in which an image is displayed, and the non-display area NDA may be an area in which the image is not displayed. In the drawings, it is described that the display area DA has a quadrangular shape. However, embodiments are not limited thereto. For example, the display area DA may have a circular, elliptical, polygonal or atypical shape. The non-display area NDA may be disposed at the periphery of the display area DA. For example, the non-display area NDA may surround the display area DA.

The first display panel DP1 may include a first display area DA1 and a first non-display area NDA1, the second display panel DP2 may include a second display area DA2 and a second non-display area NDA2, and the third display panel DP3 may include a third display area DA3 and a third non-display area NDA3.

Referring to FIG. 4, the circuit board CB disposed on the rear surfaces of the first to third display panels DP1 to DP3 may have multiple stacked structures. For example, the first to third circuit portions CB1 to CB3 may have different stacked structures.

The circuit board CB may include a first circuit board layer CBL1, a second circuit board layer CBL2 disposed on the first circuit board layer CBL1, and a third circuit board layer CBL3 disposed on the second circuit board layer CBL2. For example, the first circuit board layer CBL1, the second circuit board layer CBL2, and the third circuit board layer CBL3 may be sequentially stacked in the third direction DR3.

The first circuit board layer CBL1 may be disposed throughout the first circuit portion CB1, the second circuit portion CB2, and the third circuit portion CB3. For example, the first circuit board layer CBL1 may overlap the first to third circuit portions CB1 to CB3 in the third direction DR3.

The second circuit board layer CBL2 may be disposed throughout the first circuit portion CB1 and the second circuit portion CB2. For example, the second circuit board layer CBL2 may overlap the first and second circuit portions CB1 and CB2, and may not overlap the third circuit portion CB3 in the third direction DR3.

The third circuit board layer CBL may be disposed in the first circuit portion CB1. For example, the third circuit board layer CBL3 may overlap the first circuit portion CB1, and may not overlap the second and third circuit portions CB2 and CB3 in the third direction DR3.

In another embodiment, the second circuit board layer CBL2 may be covered by the third circuit board layer CBL3 in the first circuit portion CB1, and be exposed without being covered by the third circuit board layer CBL3 in the second circuit portion CB2.

The first circuit board layer CBL1 may be covered by the second and third circuit board layers CBL2 and CBL3 in the first circuit portion CB1, be covered by the second circuit board layer CBL2 in the second circuit portion CB2, and be exposed without being covered by the second and third circuit board layers CBL2 and CBL3 in the third circuit portion CB3.

The first circuit board layer CBL1 may overlap the third display panel DP3 in an area in which the first circuit board layer CBL1 is exposed without being covered by the second and third circuit board layers CBL2 and CBL3 (i.e., an areas the first circuit board layer CBL1 overlaps the third circuit portion CB3). The second circuit board layer CBL2 may overlap the second display panel DP2 in an area in which the second circuit board layer CBL2 is exposed without being covered by the third circuit board layer CBL3 (i.e., an area in which the second circuit board layer CBL2 overlaps the second circuit portion CB2).

The first display panel DP1 may be disposed on the third circuit board layer CBL3 in the first circuit portion CB1, the second display panel DP2 may be disposed on the second circuit board layer CBL2 in the second circuit portion CB2, and the third display panel DP3 may be disposed on the first circuit board layer CBL1 in the third circuit portion CB3.

Accordingly, a first thickness T1 of the first circuit portion CB1, a second thickness T2 of the second circuit portion CB2, and a third thickness T3 of the third circuit portion CB3 may be different from one another. This is because the first to third circuit board layers CBL1 to CBL3 may be disposed in the first circuit portion CB1, the first and second circuit board layers CBL1 and CBL2 may be disposed in the second circuit portion CB2, and the first circuit board layer CBL1 may be disposed in the third circuit portion CB3. For example, the first thickness T1 of the first circuit portion CB1 may be thicker than the second thickness T2 of the second circuit portion CB2, and the second thickness T2 of the second circuit portion CB2 may be thicker than the third thickness T3 of the third circuit portion CB3.

The first circuit board layer CBL1 may include a first base layer BL1, a first conductive layer CL1 disposed on the first base layer BL1, and a first insulating layer DL1 disposed on the first conductive layer CL1.

The first base layer BL1 may be formed of a flexible material. For example, the first base layer BL1 may include any one of polyimide, polyester, poly phenylene vinylene, and polyethylene terephthalate (PET), but the disclosure is not limited thereto. Accordingly, the circuit board CB may be bendable or foldable.

The first conductive layer CL1 may be disposed on the top of the first base layer BL1. The first conductive layer CL1 may include multiple first conductive lines (CW1 shown in FIG. 5). Each of multiple first conductive lines CW1 included in the first conductive layer CL1 may include a metal material such as copper (Cu), silver (Ag), nickel (Ni) or tungsten (W). Multiple first conductive lines CW1 may be formed by stacking or depositing a metal film on the first base layer BL1 and then performing a photoresist (PR) process, or be formed on the first base layer BL1 through a metal plating process. However, embodiments are not limited thereto.

The first insulating layer DL1 may be disposed on the top of the first conductive layer CL1. The first insulating layer DL1 may be a photoresist formed through a PR process, but the disclosure is not limited thereto. The first insulating layer DL1 may protect multiple first conductive lines CW1 included in the first conductive layer CL1 from external lines. The first insulating layer DL1 may be formed of the same material as the material constituting the first base layer BL1.

Similarly, the second circuit board layer CBL2 may include a second base layer BL2, a second conductive layer CL2 disposed on the second base layer BL2, and a second insulating layer DL2 disposed on the second conductive layer CL2. The third circuit board layer CBL3 may include a third base layer BL3, a third conductive layer CL3 disposed on the third base layer BL3, and a third insulating layer DL3 disposed on the third conductive layer CL3. The second and third base layers BL2 and BL3 may be omitted.

The second and third circuit board layers CBL2 and CBL3 may be identically configured to the first circuit board layer CBL1. For example, the second and third base layers BL2 and BL3, the second and third conductive layers CL2 and CL3, and the second and third insulating layers DL2 and DL3 may be identically configured to the first base layer BL1, the first conductive layer CL1, and the first insulating layer DL1, respectively. Therefore, more detailed description will be omitted.

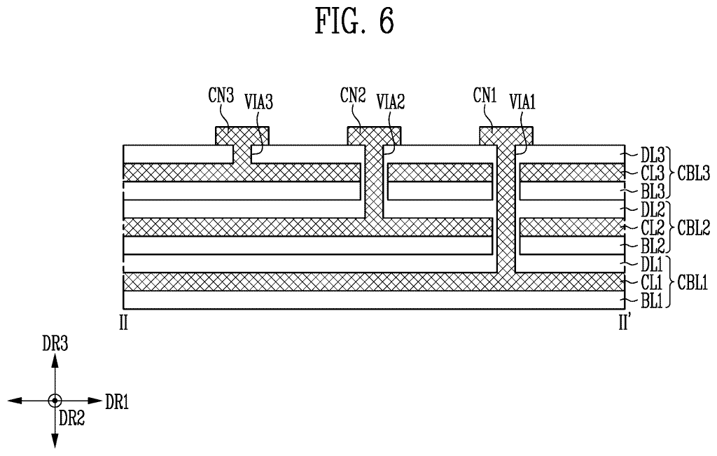

Hereinafter, the fourth circuit portion CB4 will be described in detail with reference to FIGS. 5 and 6.

FIG. 5 is an enlarged schematic plan view illustrating area A shown in FIG. 3. FIG. 6 is a schematic cross-sectional view illustrating an embodiment taken along line II-II′ shown in FIG. 5.

Referring to FIGS. 5 and 6, the fourth circuit portion CB4 of the circuit board CB may include a connector connection portion CNP electrically connected to an external connector. The connector connection portion CNP may be a coupling member for electrically connecting multiple first to third conductive lines CW1 to CW3 respectively formed in the first to third conductive layers CL1 to CL3 of the circuit board CB to a pad or lines on another substrate.

The connector connection portion CNP may include multiple first to third metal patterns CN1 to CN3. Multiple first to third metal patterns CN1, CN2, and CN3 may be circuit patterns patterned through an etching process in the first conductive layer CL1, the second conductive layer CL2, and the third conductive layer CL3.

The fourth circuit portion CB4 may include first to third via holes VIA1 to VIA3 so as to electrically connect the first to third metal patterns CN1 to CN3 and the first to third conductive layers CL1 to CL3.

The first via hole VIA1 may expose the first conductive layer CL1 while sequentially penetrating the third insulating layer DL3, the third conductive layer CL3, the third base layer BL3, the second insulating layer DL2, the second conductive layer CL2, the second base layer BL2, and the first insulating layer DL1 of the fourth circuit portion CB4. The exposed first conductive layer CL1 may be electrically connected to the first metal pattern CN1 through the first via hole VIA1. As the first conductive layer CL1 and the first metal pattern CN1 are electrically connected to each other as described above, the external connector connected to the first metal pattern CN1 and the first conductive lines CW1 of the first conductive layer CL1 may be electrically connected to each other.

The second via hole VIA2 may expose the second conductive layer CL2 while sequentially penetrating the third insulating layer DL3, the third conductive layer CL3, the third base layer BL3, and the second insulating layer DL2 of the fourth circuit portion CB4. The exposed second conductive layer CL2 may be electrically connected to the second metal pattern CN2 through the second via hole VIA2. As the second conductive layer CL2 and the second metal pattern CN2 are electrically connected to each other as described above, the external connector connected to the second metal pattern CN2 and the second conductive lines CW2 of the second conductive layer CL2 may be electrically connected to each other.

The third via hole VIA3 may expose the third conductive layer CL3 while penetrating the third insulating layer DL3 of the fourth circuit portion CB4. The exposed third conductive layer CL3 may be electrically connected to the third metal pattern CN3 through the third via hole VIA3. As the third conductive layer CL3 and the third metal pattern CN3 are electrically connected to each other as described above, the external connector connected to the third metal pattern CN3 and the third conductive lines CW3 of the third conductive layer CL3 may be electrically connected to each other.

The first to third metal patterns CN1 to CN3 are electrically connected to the external connector to appl an electrical signal to the first to third conductive lines CW1 to CW3 formed in the first to third conductive layers CL1 to CL3.

In the display device 10 in accordance with the embodiments of the disclosure, the first to third display panels DP1 to DP3 may be disposed on the first to third circuit portions CB1 to CB3 having different thicknesses, so that an individual signal can be applied to each of the first to third display panels DP1 to DP3. Accordingly, the display device 10 can be driven to be suitable for a desired image.

In the display device 10 in accordance with the embodiments of the disclosure, a driving signal can be applied to each of the first to third display panels DP1 to DP3 while the first to third display panels DP1 to DP3 are disposed on one circuit board without using any individual circuit board for each of the first to third display panels DP1 to DP3. Accordingly, the miniaturization and portability of the display device are possible. Further, one circuit board is used, so that cost can be reduced.

Hereinafter, the first to third display panels DP1 to DP3 disposed on the circuit board CB will be described in detail with reference to FIGS. 7 to 16.

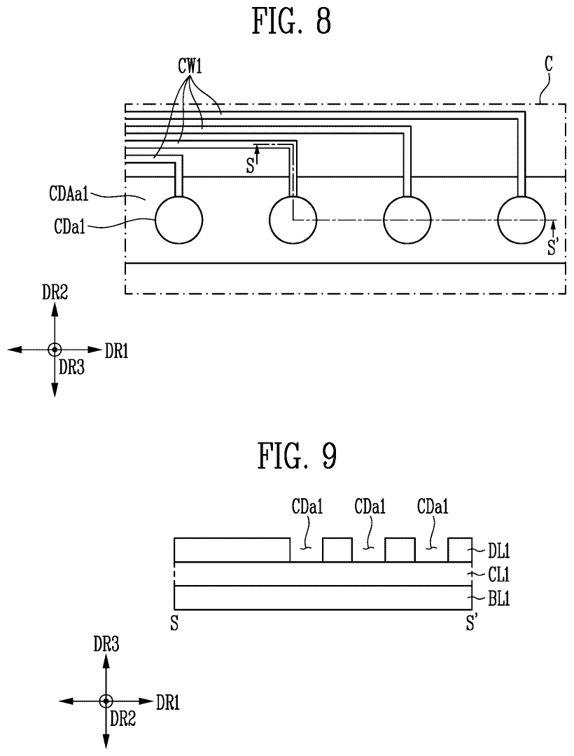

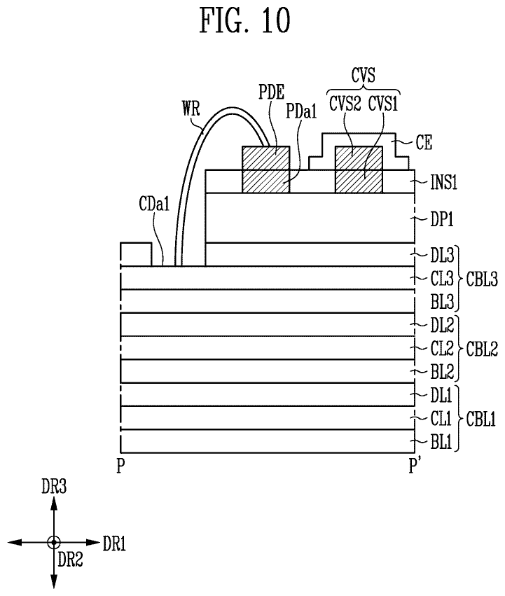

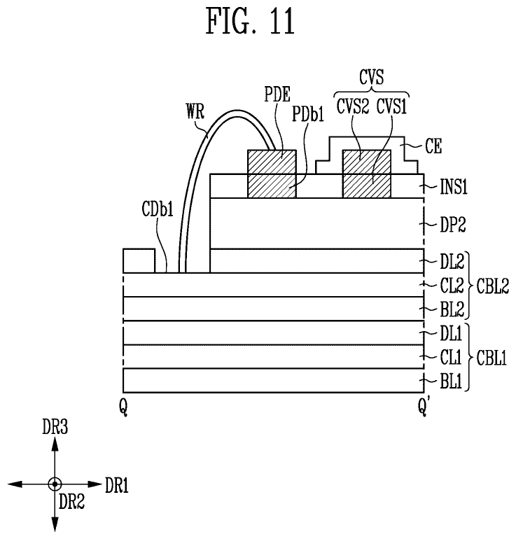

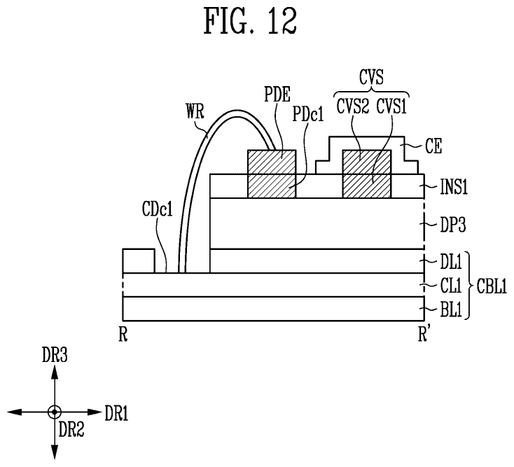

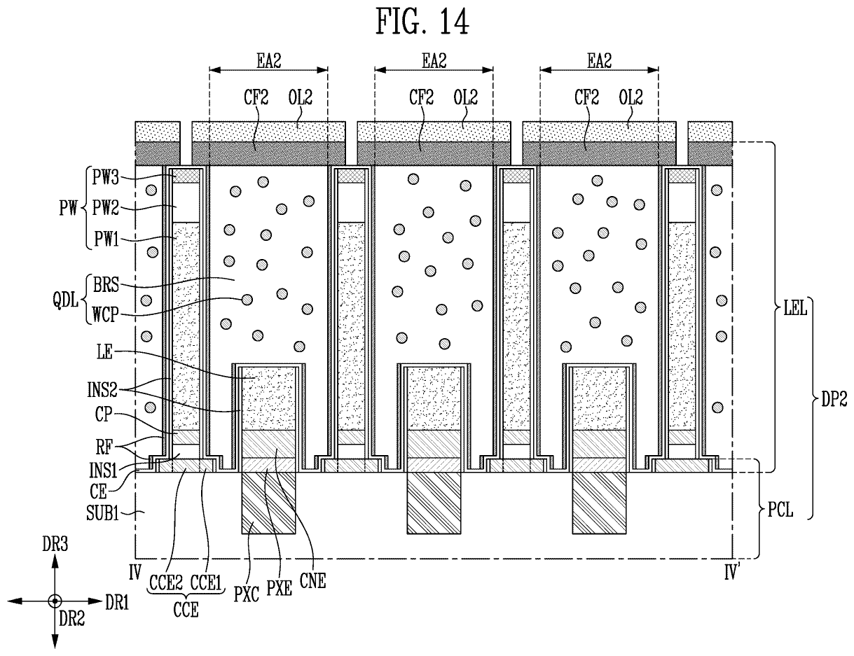

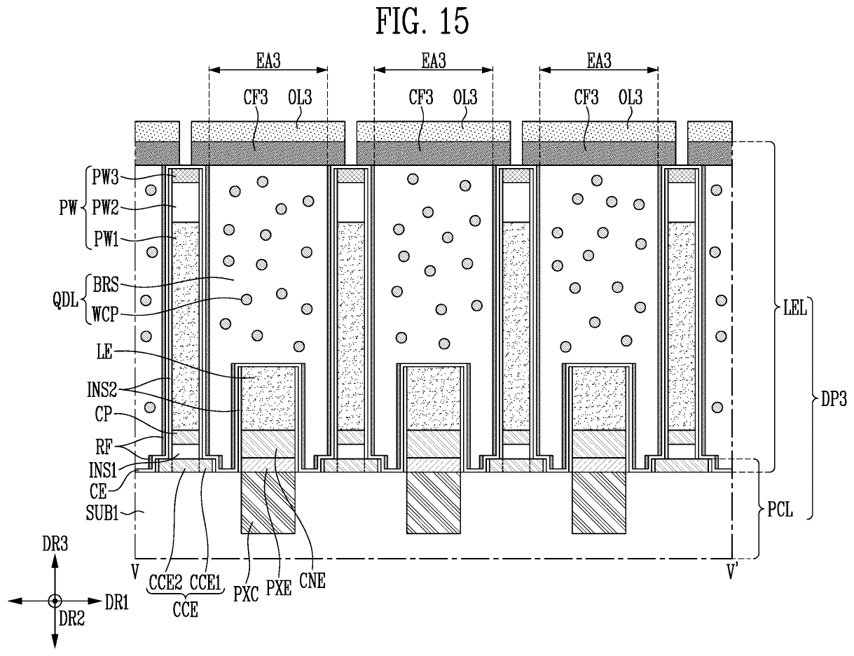

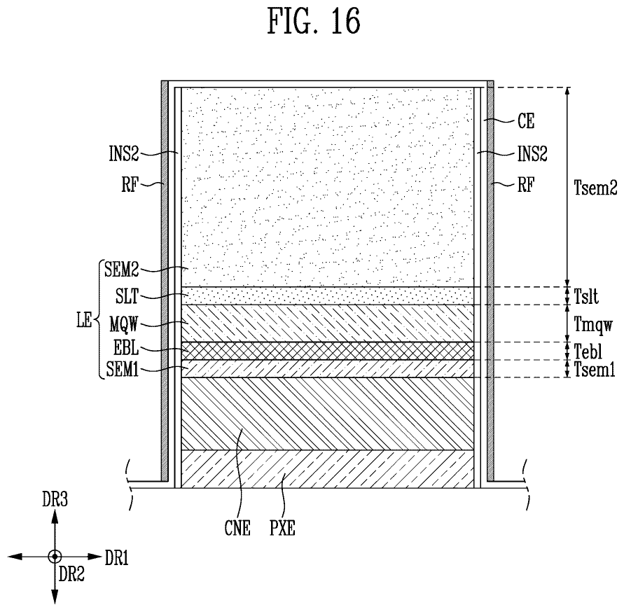

FIG. 7 is an enlarged schematic plan view illustrating area B shown in FIG. 3. FIG. 8 is an enlarged schematic plan view illustrating area C shown in FIG. 7. FIG. 9 is a schematic cross-sectional view illustrating an embodiment taken along line S-S′ shown in FIG. 8. FIG. 10 is a schematic cross-sectional view illustrating an embodiment taken along line P-P′ shown in FIG. 3. FIG. 11 is a schematic cross-sectional view illustrating an embodiment taken along line Q-Q′ shown in FIG. 3. FIG. 12 is a schematic cross-sectional view illustrating an embodiment taken along line R-R′ shown in FIG. 3. FIG. 13 is a schematic cross-sectional view illustrating an embodiment taken along line III-III′ shown in FIG. 3. FIG. 14 is a schematic cross-sectional view illustrating an embodiment taken along line IV-IV′ shown in FIG. 3. FIG. 15 is a schematic cross-sectional view illustrating an embodiment taken along line V-V′ shown in FIG. 3. FIG. 16 is a schematic cross-sectional view illustrating a light emitting element of an embodiment of the disclosure.

Referring to FIGS. 3 and 7 together, the first display area DA1 of the first display panel DP1 may include a plurality of pixels PX. The pixels PX may be provided in a minimum light emitting unit in which light of any one of red, green, and blue can be displayed.

Each of multiple pixels PX included in the first display panel DP1 may include a first emission area EA1 in which light is emitted.

The first emission area EA1 may include a light emitting element LE emitting light. Although it is described that the light emitting element LE has a circular planar shape in a plan view, embodiments are not limited thereto. For example, the light emitting element LE may have a shape of a polygon including a quadrangle or an ellipse.

Each of the first emission areas EA1 may be an area in which the first light L1 is emitted. Each of the first emission areas EA1 may output the first light L1 output from the light emitting element LE. As described above, the first light L1 may be light in a blue wavelength band.

Each of the first emission area EA1 may be partitioned by a partition wall PW. The partition wall PW may be disposed to surround the light emitting element LE. The partition wall PW may be disposed to be spaced apart from the light emitting element LE. The partition wall PW may have a planar shape of a mesh, a net, or a lattice.

The first emission area EA1 defined by the partition wall PW may have a circular planar shape in a plan view, but embodiments are not limited thereto. For example, the first emission area EA1 defined by the partition wall PW may have a planar shape of a polygon including a quadrangle or an ellipse.

The first non-display area NDA1 of the first display panel DP1 may include a first common voltage supply area CVAa1, a second common voltage supply area CVAa2, a first pad portion PDAa1, and a second pad portion PDAa2.

The first common voltage supply area CVAa1 may be disposed between the first pad portion PDAa1 and the first display area DA1. The second common voltage supply area CVAa2 may be disposed between the second pad portion PDAa2 and the first display area DA1. Each of the first common voltage supply area CVAa1 and the second common voltage supply area CVAa2 may include multiple common voltage supply portions CVS electrically connected to a common electrode (CE shown in FIGS. 10 to 16). A common voltage may be supplied to the common electrode CE through multiple voltage supply portions CVS.

Multiple common voltage supply portions CVS of the first common voltage supply area CVAa1 may be electrically connected to any one of first pads PDa1 of the first pad portion PDAa1. For example, multiple common voltage supply portions CVS of the first common voltage supply area CVAa1 may be supplied with the common voltage from any one of the first pads PDa1 of the first pad portion PDAa1.

Multiple common voltage supply portions CVS of the second common voltage supply area CVAa2 may be electrically connected to any one of second pads of the second pad portion PDAa2. For example, multiple common voltage supply portions CVS of the second common voltage supply area CVAa2 may be supplied with the common voltage from any one of the second pads of the second pad portion PDAa2.

The first pad portion PDAa1 may be disposed at an upper side of the first display panel DP1 in the second direction DR2. The first pad portion PDAa1 may include first pads PDa1 electrically connected to the first circuit portion CB1 of the circuit board CB.

The second pad portion PDAa2 may be disposed at a lower side of the first display panel DP1. The second pad portion PDAa2 may include second pads electrically connected to the first circuit portion CB1 of the circuit board CB.

The circuit board CB disposed on the rear surface of the first display panel DP1 may include a first circuit pad portion CDAa1 and a second circuit pad portion CDAa2 in the first circuit portion CB1.

The first circuit pad portion CDAa1 may be disposed at an upper side of the first pad portion PDAa1 of the first display panel DP1 in the second direction DR2. The first circuit pad portion CDAa1 may include first circuit pads CDa1 electrically connected to the first display panel DP1. Although will be described later, each of the first pads PDa1 of the first display panel DP1 may be electrically connected to each of the first circuit pads CDa1 of the first circuit portion CB1 through a wire (WR shown in FIGS. 10 to 12.

The second circuit pad portion CDAa2 may be disposed at a lower side of the second pad portion PDAa2 of the first display panel DP1 in the second direction DR2. The second circuit pad portion CDAa2 may include second circuit pads electrically connected to the first display panel DP1.

As depicted in FIG. 3, each of the first pad portion PDAa1, the second pad portion PDAa2, the first circuit pad portion CDAa1, and the second circuit pad portion CDAa2 may be disposed at an upper side or a lower side of the first display panel DP1 in the second direction DR2. However, the disclosure is not limited thereto, and each of the first pad portion PDAa1, the second pad portion PDAa2, the first circuit pad portion CDAa1, and the second circuit pad portion CDAa2 may be disposed at a right side or a left side of the first display panel DP1 in the first direction DR1.

Referring to FIGS. 8 and 9, the first circuit pads CDa1 of the first circuit pad portion CDAa1 may be electrically connected to multiple first conductive lines CW1 included in the first conductive layer CL1. Although not shown in the drawings, the second circuit pads of the second circuit pad portion CDAa2 may be electrically connected to multiple first conductive lines CW1, like the first circuit pads CDa1.

The first circuit pads CDa1 of the first circuit portion CB1 may be patterns formed in an area in which the first insulating layer DL1 disposed on the first conductive layer CL1 is etched.

The first conductive line CW1, the first circuit pad CDa1, the wire WR, and the first pad PDa1 may be electrically connected to each other. The first display panel DP1 may be supplied with an external driving signal through multiple first conductive lines CW1.

In case that referring to FIG. 7, the second and third display panels DP2 and DP3 are different from the first display panel DP1 including the first emission area EA1, in that each of multiple pixels PX included in the second and third display panels DP2 include second and third emission areas EA2 and EA3. The second and third display panels DP2 and DP3 may be identically configured to the first display panel DP1 at a portion corresponding to FIG. 7 illustrating enlarged view B, and accordingly, enlarged views of the portion corresponding to FIG. 7 illustrating the enlarged view B with respect to the second and third display panels DP2 and DP3 will be omitted.

Referring to FIGS. 10 to 16, each of the first to third display panels DP1 to DP3 may include a pixel circuit layer PCL and a light emitting element layer LEL.

Referring to FIGS. 10 and 13, a pixel circuit layer PCL of the first display panel DP1 may be disposed on the third circuit board layer CBL3 in the first circuit portion CB1.

Referring to FIGS. 11 and 14, a pixel circuit layer PCL of the second display panel DP2 may be disposed on the second circuit board layer CBL2 in the second circuit portion CB2.

Referring to FIGS. 12 and 15, a pixel circuit layer PCL of the third display panel DP3 may be disposed on the first circuit board layer CBL1 in the third circuit portion CB3.

The pixel circuit layer PCL may include a first substrate SUB1, multiple pixel circuit portions PXC, pixel electrodes PXE, first pads PDa1, PDb1, and PDc1, second pads, and first common voltage supply portions CVS1.

The first substrate SUB1 may be silicon wafer substrate. The first substrate SUB1 may be made of single crystalline silicon.

Each of multiple pixel circuit portions PXC may be disposed in the first substrate SUB1. Each of multiple pixel circuit portions PXC may include a complementary metal-oxide semiconductor (CMOS) circuit formed using a semiconductor process. Each of multiple pixel circuit portions PXC may include at least one transistor formed through a semiconductor process. Each of multiple pixel circuit portions PXC may further include at least one capacitor formed through a semiconductor process.

Multiple pixel circuit portions PXC may be disposed in the display area DA. Each of multiple pixel circuit portions PXC may be electrically connected to a pixel electrode PXE corresponding thereto. Any one pixel circuit portion PXC and any one pixel electrode PXE may be electrically connected to each other to correspond one-to-on to each other. Each of multiple pixel circuit portions PXC may apply a pixel voltage or an anode voltage to the pixel electrode PXE.

Each of the pixel electrodes PXE may be disposed on the pixel circuit portion PXC corresponding thereto. Each of the pixel electrodes PXE may be an electrode exposed from the pixel circuit portion PXC. Each of the pixel electrodes PXE may protrude from a top surface of the pixel circuit portion PXC. Each of the pixel electrodes PXE may be supplied with a pixel voltage or an anode voltage from the pixel circuit portion PXC. The pixel electrodes PXE may include aluminum (Al).

Referring to FIGS. 10 to 12, each of the first pads PDa1, PDb1, and PDc1 and the first common voltage supply portions CVS1 may be exposed electrodes exposed from the first substrate SUB1. Each of the first pads PDa1, PDb1, and PDc1 and the first common voltage supply portions CVS1 may be made of the same material as the pixel electrodes PXE. For example, each of the first pads PDa1, PDb1, and PDc1 and the first common voltage supply portions CVS1 may include aluminum (Al). Second pads of second pad portions PDAa2, PDAb2, and PDAc2 may be substantially identical to the first pads PDa1, PDb1, and PDc1, and therefore, their descriptions will be omitted.

Referring to FIGS. 13 to 15, the light emitting element layer LEL may be a layer including each of a first emission area EA1, a second emission area EA2, and a third emission area EA3, thereby emitting light in a specific wavelength band.

The light emitting element LEL may include connection electrodes CNE, a pad connection electrode PDE, a second common voltage supply portion CVS2 of the common voltage supply portion CVS, a common connection electrode CCE, light emitting elements LE, a first insulating layer INS1, a conductive pattern CP, a partition wall PW, a second insulating layer INS2, a common electrode CE, a reflective layer RF, multiple first to third color filters CF1 to CF3, first to third optical lenses OL1 to OL3, and first to third dichroic mirrors DM1 to DM3. A light emitting element layer LEL of the second display panel DP2 and a light emitting element layer LEL of the third display panel DP3 may include a wavelength conversion layer QDL. However, a light emitting element layer LEL of the first display panel DP1 may include a transparent layer TPL instead of the wavelength conversion layer QDL.

Each of the connection electrodes CNE may be disposed on a pixel electrode PXE corresponding thereto. The connection electrodes CNE may be electrically connected one-to-one to pixel electrodes PXE corresponding thereto. The connection electrodes CNE may serve as a bonding metal for allowing the pixel electrodes PXE and the light emitting elements LE to be adhered to each other in a manufacturing process. For example, the connection electrodes CNE may include at least one of gold (Au), copper (Cu), aluminum (Al), and tin (Sn). Alternatively, the connection electrodes CNE may include a first layer including any one of gold (Au), copper (Cu), aluminum (Al), and tin (Sn) and a second layer including another of gold (Au), copper (Cu), aluminum (Al), and tin (Sn). The second layer may be disposed on the first layer.

The common connection electrode CCE may be electrically separated from the pixel electrode PXE and the connection electrode CNE. The common connection electrode CCE may surround the pixel electrode PXE and the connection electrode CNE in a state in which the pixel electrode PXE and the connection electrode CNE are spaced apart from each other at a predetermined distance.

The common connection electrode CCE may include a first common connection electrode CCE1 disposed in the first to third emission area EA1 to EA3 and a second common connection electrode CCE2 overlapping the partition wall PW in the third direction DR3.

The common connection electrode CCE may be electrically connected to any one of the first pads PDa1, PDb1, and PDC1 of the first pad portions PDAa1, PDAb1, and PDAc1 of the first to third non-display area NDA1 to NDA3 or any one of the second pads of the second pad portions PDAa2, PDAb2, and PDAc2 to be supplied with a common voltage. The common connection electrodes CCE may include the same material as the connection electrodes CNE. For example, the common connection electrode CCE may include at least one of gold (Au), copper (Cu), aluminum (Al), and tin (Sn). In case that each of the connection electrodes CNE includes a first layer and a second layer, the common connection electrode CCE may include the same material as the first layer of each of the connection electrodes CNE.

The pad connection electrode PDE may be disposed on the first pads PDa1, PDb1, and PDc1, and the second common voltage supply portion CVS2 may be disposed on the first common voltage supply portion CVS1. The pad connection electrode PDE may be in contact with top surfaces of the first pads PDa1, PDb1, and PDc1, and the second common voltage supply portion CVS2 may be in contact with a top surface of the first common voltage supply portion CVS1. The pad connection electrode PDE and the second common voltage supply portion CVS2 may include the same material as the connection electrodes CNE. For example, the pad connection electrode PDE and the second common voltage supply portion CVS2 may include at least one of gold (Au), copper (Cu), aluminum (Al), and tin (Sn). In case that each of the connection electrodes CNE includes a first layer and a second layer, each of the pad connection electrode PDE and the second common voltage supply portion CVS2 may include a first layer and a second layer.

The pad connection electrode PDE may be electrically connected to a circuit pad of a circuit pad portion of the circuit board CB through a conductive connection member such as a wire WR. For example, the first pads PDa1, PDb1, and PDc1, the pad connection electrode PDE, the wire WR, and the first circuit pads CDa1, CDb1, and CDc1 of the circuit board CB may be electrically connected to each other.

Accordingly, a driving signal for driving the first display panel DP1 may be applied through multiple first conductive lines CW1, to be transferred to the first circuit pad CDa1, the wire WR, the pad connection electrode PDE, and the first pad PDa1. A driving signal for driving the second display panel DP2 may be applied through multiple second conductive lines CW2, to be transferred to the first circuit pad CDb1, the wire WR, the pad connection electrode PDE, and the first pad PDb1. A driving signal for driving the third display panel DP3 may be applied through multiple third conductive lines CW3, to be transferred to the first circuit pad CDC1, the wire WR, the pad connection electrode PDE, and the first pad PDc1.

The first display panel DP1, the second display panel DP2, and the third display panel DP3 may be separately driven from one another.

The light emitting element layer LEL of the first display panel DP1 may include a first emission area EA1 partitioned by the partition wall PW as shown in FIG. 13. The light emitting element layer LEL of the second display panel DP2 may include a second emission area EA2 partitioned by the partition wall PW as shown in FIG. 14. The light emitting element layer LEL of the third display panel DP3 may include a third emission area EA3 partitioned by the partition wall PW as shown in FIG. 15.

Multiple light emitting elements LE, a transparent layer TPL, multiple first color filters CF1, a first optical lens OL1, and a first dichroic mirror DM1 may be disposed in the first emission area EA1.

Multiple light emitting elements LE, a wavelength conversion layer QDL, multiple second color filters CF2, a second optical lens OL2, and a second dichroic mirror DM2 may be disposed in the second emission area EA2.

Multiple light emitting elements LE, a wavelength conversion layer QDL, multiple third color filters CF3, a third optical lens OL3, and a third dichroic mirror DM3 may be disposed in the third emission area EA3.

As depicted in FIGS. 13 to 15, for convenience of description, illustration of the first to third dichroic mirrors DM1 to DM3 is omitted. Although not shown in the drawings, the first to third dichroic mirrors DM1 to DM3 may be disposed at upper sides of the first to third optical lenses OL1 to OL3 as shown in FIGS. 1 and 2.

Each of the light emitting elements LE may be disposed on the connection electrode CNE. The light emitting element LE may be a vertical light emitting diode element extending in the third direction DR3 (e.g., thickness direction). For example, a length of the light emitting element LE in the third direction DR3 may be longer than a length of the light emitting element LE in a horizontal direction. The length of the light emitting element LE in the horizontal direction indicates a length of the light emitting element LE in the first direction DR1 or a length of the light emitting element LE in the second direction DR2. For example, the length of the light emitting element LE in the third direction DR3 may be about 1 μm to about 5 μm.

The light emitting element LE may be a micro light emitting diode element or a nano light emitting diode element.

Referring to FIG. 16, the light emitting element LE may include a first semiconductor layer SEM1, an electron blocking layer EBL, an active layer MQW, a superlattice layer SLT, and a second semiconductor layer SEM2 in the third direction DR3. For example, the first semiconductor layer SEM1, the electron blocking layer EBL, the active layer MQW, the superlattice layer SLT, and the second semiconductor layer SEM2 may be sequentially stacked in the third direction DR3.

The first semiconductor layer SEM1 may be disposed on the connection electrode CNE. The first semiconductor layer SEM may be doped with a first conductivity type dopant such as magnesium (Mg), zinc (Zn), calcium (Ca), selenium (Se) or barium (Ba). For example, the first semiconductor layer SEM1 may be p-type gallium nitride (p-GaN) doped with p-type magnesium (Mg). A thickness Tsem1 of the first semiconductor layer SEM1 may be about 30 nm to about 200 nm.

The electron blocking layer EBL may be disposed on the first semiconductor layer SEM1. The electron blocking layer EBL may be a layer for suppressing or preventing too many electrons from flowing into the active layer MQW. For example, the electron blocking layer EBL may be p-type aluminum gallium nitride (p-AlGaN) doped with p-type magnesium (Mg). A thickness Tebl of the electron blocking layer EBL may be about 10 nm to about 50 nm. However, in another embodiment, the electron blocking layer EBL may be omitted.

The active layer MQW may be disposed on the electron blocking layer EBL. The active layer MQW may emit light by coupling of electron-hole pairs according to an electrical signal applied through the first semiconductor layer SEM1 and the second semiconductor layer SEM2. The active layer MQW may emit the third light L3 having of which central wavelength band has a range of about 450 nm to about 495 nm, i.e., light in a blue wavelength band.

The active layer MQW may include a material having a single or multiple quantum well structure. In case that the active layer MQW includes a material having a multiple quantum well structure, the active layer MQW may have the structure in which multiple well layers and barrier layers are alternately stacked. The well layer may be formed of indium gallium nitride (InGaN), and the barrier layer may be formed of gallium nitride (GaN) or aluminum gallium nitride (AlGaN). However, the disclosure is not limited thereto. A thickness of the well layer may be about 1 nm to about 4 nm, and a thickness of the barrier layer may be about 3 nm to about 10 nm. Thus, a thickness Tmqw of the active layer MQW may be about 4 nm to about 14 nm.

The active layer MQW may have a structure in which semiconductor materials having large band gap energy and semiconductor materials having small band gap energy are alternately stacked, and include other Group III to Group V semiconductor materials according to a wavelength band of emitted light. The light emitted by the active layer MQW is not limited to the third light L3 in the blue wavelength band, and in some cases, the active layer MQW may emit the second light L2 in the green wavelength band or first light L2 in a red wavelength band.

The superlattice layer SLT may be disposed on the active layer MQW. The superlattice layer SLT may be a layer for relieving stress between the second semiconductor layer SEM2 and the active layer MQW. For example, the superlattice layer SLT may be formed of InGaN or GaN. A thickness Tslt of the superlattice layer SLT may be about 50 nm to about 200 nm. The superlattice layer SLT may be omitted.

The second semiconductor layer SEM2 may be disposed on the superlattice layer SLT. The second semiconductor layer SEM2 may be doped with a second conductivity type dopant such as silicon (Si), germanium (Ge) or tin (Sn). For example, the second semiconductor layer SEM2 may be n-type gallium nitride (n-GaN) doped with n-type silicon (Si). A thickness Tsem2 of the second semiconductor layer SEM2 may be about 500 nm to about 1 μm.

The first insulating layer INS1 may be disposed on the common connection electrode CCE. The first insulating layer INS1 may be formed of an inorganic layer such as a silicon oxide layer (SiO₂), an aluminum oxide layer (Sl₂O₃), or a hafnium oxide layer (HfOₓ).

Referring back to FIGS. 13 to 15, the conductive pattern CP may be disposed on the first insulating layer INS1. The conductive pattern CP may be disposed between the first insulating layer INS1 and the partition wall PW in the third direction DR3.

The conductive pattern CP may correspond to a remainder formed through the same process as the connection electrodes CNE and the common connection electrode CCE. Therefore, the conductive pattern CP may include the same material as the connection electrodes CNE and the common connection electrode CCE. For example, the conductive pattern CP may include at least one of gold (Au), copper (Cu), aluminum (Al), and tin (Sn). In case that each of the connection electrodes CNE includes a first layer and a second layer, the conductive pattern CP may include the same material as the second layer of each of the connection electrodes CNE.

The partition wall PW may be disposed on the conductive pattern CP. The partition wall PW may be disposed to be spaced apart from each of the light emitting elements LE. The partition wall PW may be disposed to surround the light emitting elements LE while being spaced apart from each of the light emitting elements LE at a predetermined distance, and partition the first to third emission areas EA1, EA2, and EA3.

The partition wall PW may include a first partition wall PW1, a second partition wall PW2, and a third partition wall PW3 as shown in FIGS. 13 to 15, but embodiments are not limited thereto. At least a partial area of the first partition wall PW1 may include the same material as the light emitting element LE. The second partition wall PW may be disposed on the first partition wall PW1, and be formed of an inorganic layer such as a silicon oxide layer (SiO₂), an aluminum oxide layer (Sl₂O₃), or a hafnium oxide layer (HfOₓ). The third partition wall PW3 may be disposed on the second partition wall PW2. The third partition wall PW3 may include a conductive material such as nickel (Ni).

The second insulating layer INS2 may be disposed on side surfaces of the common connection electrode CCE, side surfaces of the partition wall PW, side surfaces of each of the pixel electrodes PXE, side surfaces of each of the connection electrodes CNE, and side surfaces of each of the light emitting elements LE. The second insulating layer INS2 may be formed of an inorganic layer such as a silicon oxide layer (SiO₂), an aluminum oxide layer (Sl₂O₃), or a hafnium oxide layer (HfOₓ). A thickness of the second insulating layer INS2 may be about 0.1 μm.

The common electrode CE may be disposed on a top surface and side surfaces of each of the light emitting elements LE and a top surface and side surfaces of the partition wall PW. For example, the common electrode CE may be disposed to cover the top surface and the side surfaces of each of the light emitting elements LE and the top surface and the side surfaces of the partition wall PW.

The common electrode CE may be in contact with the second insulating layer INS2 disposed on side surfaces of the first common connection electrode CCE1, the side surface of the partition wall PW, the side surfaces of each of the pixel electrodes PXE, the side surfaces of each of the connection electrodes CNE, and the side surfaces of each of the light emitting elements LE. The common electrode CE may be in contact with a top surface of the first common connection electrode CCE1, the top surface of each of the light emitting elements LE, and the top surface of the partition wall PW.

The common electrode CE may be in contact with the top surface of the first common connection electrode CCE1 and the top surface of the light emitting element LE, which are exposed without being covered by the second insulating layer INS2 at an edge of each of the first to third emission areas EA1, EA2, and EA3. Accordingly, a common voltage supplied to the common connection electrode CCE may be supplied to the light emitting element LE. One end of the light emitting element LE may be supplied to a pixel voltage or an anode voltage of the pixel electrode PXE through the connection electrode CNE, and the other end of the light emitting element LE may be supplied to the common voltage through the common electrode CE. The light emitting element LE may emit light with a predetermined luminance according to a voltage difference between the pixel voltage and the common voltage.

The common electrode CE may include a transparent conductive material. The common electrode CE may be formed of a transparent conductive oxide (TCO) such as indium tin oxide (ITO) or indium zinc oxide (IZO). A thickness of the common electrode CE may be about 0.1 μm.

The reflective layer RF may function to reflect lights advancing in lower left/right side directions instead of an upper direction among lights emitted from the light emitting element LE. The reflective layer RF may include a metal material having high reflectivity, such as aluminum (Al). A thickness of the reflective layer may be about 0.1 μm. The reflective layer RF may be in contact with the common electrode CE.

Referring back to FIG. 13, the transparent layer TPL may be disposed over the light emitting element LE in the first emission area EA1. The transparent layer TPL may cover the light emitting element LE in the first emission area EA1.

The transparent layer TPL may include a light transmissive organic material. For example, a base resin BRS may include an epoxy-based resin, an acryl-based resin, a cardo-based resin, an imide-base resin, or the like. The transparent layer TPL does not absorb the first light L1 incident from the light emitting element LE, but may allow the first light L1 to be transmitted as it is therethrough. For example, the transparent layer TPL does not absorb light in a blue wavelength band, but may allow the light to be transmitted as it is therethrough.

The first color filter CF1 may be disposed on the transparent layer TPL in the first emission area EA1. The first color filter CF1 may be disposed on the partition wall PW. The first color filter CF1 may allow the first light L1 to be transmitted therethrough, and absorb or block second and third lights L2 and L3.

The first optical lens OL1 may be disposed on the first color filter CF1 in the first emission area EA1. As depicted in FIG. 13, one first optical lens OL1 may be disposed on each first color filter CF1 to correspond one-to-one to the first color filter CF1. However, embodiments are not limited thereto. For example, the first optical lens OL1 may have a size and a shape, which correspond to the first display area DA1, to extend in first and second directions DR1 and DR2 and cover the whole surface of the first display area (DA1 shown in FIG. 1). The first optical lens OL1 may cover (e.g., entirely cover) multiple first color filters CF1 and black matrixes disposed therebetween. Meanwhile, as described with reference to FIG. 2, the first optical lens OL1 may collimate the first light L1 transmitted through the first color filter CF1 into the first collimated light COL1, thereby guiding the first collimated light COL1 toward the first dichroic mirror DM1.

Although not shown in the drawing, a black matrix may be disposed between the first color filters CF1 in the first direction DR1. The black matrix may include an inorganic black pigment such as carbon black or an organic black pigment. The black matrix may be disposed between the first optical lenses OL1.

The first dichroic mirror DM1 may be disposed on the optical path of the first collimated light COL1 collimated by the first optical lens OL1, reflect the first collimated light COL1 as the first reflected light RL1. This has been described in detail with reference to FIGS. 1 and 2, and therefore, overlapping descriptions will be omitted.

Referring to FIGS. 14 and 15, the wavelength conversion layer QDL may be disposed over the light emitting element LE in the second and third emission areas EA2 and EA3. The wavelength conversion layer QDL may be disposed to cover the light emitting element LE in the second and third emission areas EA2 and EA3.

The wavelength conversion layer QDL may include a base resin BRS and a wavelength conversion particle WCP. The base resin BRS may include a light transmissive organic material. For example, the base resin BRS may include an epoxy-based resin, an acryl-based resin, a cardo-based resin, an imide-base resin, or the like.

The wavelength conversion particles WCP may convert the third light L3 incident from the light emitting element LE into the first light L1 or convert the second light L2 incident from the light emitting element LE into the first light L1. For example, the wavelength conversion particle WCP may convert light in a red wavelength band into light in a blue wavelength band. The wavelength conversion particle WCP may convert light in a green wavelength band into light in a blue wavelength band. The wavelength conversion particle WCP may be a quantum dot (QD), a quantum rod, a fluorescent material, or a phosphorescent material. The quantum dot (QD) may include a Group IV nano crystal, a Group II-VI compound nanocrystal, a Group III-V compound nanocrystal, a Group IV-VI nanocrystal, or any combination thereof.

The quantum dot (QD) may include a core and a shell overcoating the core. The core is not limited thereto, and may be, for example, at least one of CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe₂O₃, Fe₃O₄, Si, and Ge. The shell is not limited thereto, and may include, for example, at least one of ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, and PbTe.

The wavelength conversion layer QDL may further include a scatterer for scatting light of the light emitting element LE in a random direction. The scatterer may include a metal oxide particle or an organic particle. For example, the metal oxide may be titanium oxide (TiO₂), zirconium oxide (ZrO₂), aluminum oxide (Al₂O₃), indium oxide (In₂O₃), zinc oxide (ZnO), or tin oxide (SnO₂). The organic particle may include an acryl-based resin or a urethane-based resin. A diameter of the scatterer may be a few to tens of nanometers.

The second color filter CF2 may be disposed on the wavelength conversion layer QDL in the second emission area EA2. Similarly, the third color filter CF3 may be disposed on the wavelength conversion layer QDL in the third emission area EA3. The second and third color filters CF2 and CF3 may be disposed on the partition wall PW. The second color filter CF2 may allow the second light L2 to be transmitted therethrough, and absorb or block the first and third lights L1 and L3. The third color filter CF3 may allow the third light L3 to be transmitted therethrough, and absorb or block the first and second lights L1 and L2.

Although not shown in the drawings, a black matrix may be disposed between the second and third color filters CF2 and CF3 in the first direction DR1. The black matrix may include an inorganic black pigment such as carbon black or an organic black pigment. The black matrix may be disposed between the second and third optical lenses OL2 and OL3.

The second optical lens OL2 may be disposed on the second color filter CF2 in the second emission area EA2. As depicted in FIG. 14, one second optical lens OL2 may be disposed on each second color filter CF2 to correspond one-to-one to the second color filter CF2. However, embodiments are not limited thereto. For example, the second optical lens OL2 may have a size and a shape, which correspond to the second display area (DA2 shown in FIG. 3), to extend in the first and second directions DR1 and DR2 and cover the whole surface of the second display area DA2. The second optical lens OL2 may cover (e.g., entirely cover) multiple second color filters CF2 and black matrixes disposed therebetween. Meanwhile, as described with reference to FIG. 2, the second optical lens OL2 may collimate the second light L2 transmitted through the second color filter CF2 into the second collimated light COL2, thereby guiding the second collimated light COL2 toward the second dichroic mirror DM2.

The third optical lens OL3 may be disposed on the third color filter CF3 in the third emission area EA3. As depicted in FIG. 14, one third optical lens OL3 may be disposed on each third color filter CF3 to correspond one-to-one to the third color filter CF3. However, embodiments are not limited thereto. For example, the third optical lens OL3 may have a size and a shape, which correspond to the third display area (DA3 shown in FIG. 3), to extend in the first and second directions DR1 and DR2 and cover the whole surface of the third display area DA3. The third optical lens OL3 may cover (e.g., entirely cover) multiple third color filters CF3 and black matrixes disposed therebetween. Meanwhile, as described with reference to FIG. 2, the third optical lens OL3 may collimate the third light L3 transmitted through the third color filter CF3 into the third collimated light COL3, thereby guiding the third collimated light COL3 toward the third dichroic mirror DM3.

The second dichroic mirror DM2 may be disposed at a position at which the optical path of the second collimated light COL2 collimated by the second optical lens OL2 and the optical path of the first reflected light RL1 transmitted through the first dichroic mirror DM1 meet each other, to reflect the second collimated light COL2 as the second reflected light RL2 and allow the first reflected light RL1 reflected from the first dichroic mirror DM1 to be transmitted as the (1_1)st transmitted light TL1_1 therethrough. This has been described in detail with reference to FIGS. 1 and 2, and therefore, overlapping descriptions will be omitted.

The third dichroic mirror DM3 may be disposed at a position at which the optical path of the optical path of the (1_1)st transmitted light TL1_1 transmitted through the second dichroic mirror DM2 and the optical path of the second reflected light RL2 reflected from the second dichroic mirror DM2 meet each other, to reflect the third collimated light COL3 as the third reflected light RL3, allow the (1_1)st transmitted light to be transmitted as the (1_2)nd transmitted light TL1_2 therethrough, and allow the second reflected light RL2 as the second transmitted light TL2 therethrough. This has been described in detail with reference to FIGS. 1 and 2, and therefore, overlapping descriptions will be omitted.

In the display device 10 in accordance with the embodiments of the disclosure, the first to third display panels DP1 to DP3 emitting lights having different wavelengths may be disposed on one circuit board CB having different thicknesses, so that the display device 10 can be implemented compact, and cost can be reduced.

The first to third display panels DP1 to DP3 emitting lights having different wavelengths are laterally disposed on a plane formed by the first and second directions DR1 and DR2, and the first to third optical lenses OL1 to OL3 and the first to third dichroic mirrors DM1 to DM3 are respectively disposed on optical paths, so that heat generation and degradation of the display device 10 can be reduced or prevented, and the weight and volume of the display device 10 can be decreased.

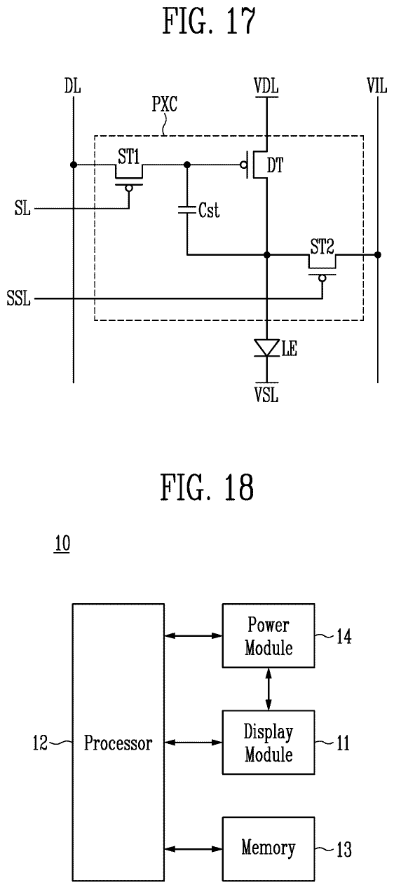

FIG. 17 is a schematic diagram of an equivalent circuit of a pixel of an embodiment of the disclosure.

Referring to FIG. 17, each of multiple pixels PX may include a light emitting element LE and a pixel circuit portion PXC which controls an emission amount of the light emitting element LE. The emission amount of the light emitting element LE may be in proportion to a driving current. The light emitting element LE may be an inorganic light emitting element including an anode electrode, a cathode electrode, and an inorganic semiconductor disposed between the anode electrode and the cathode electrode. For example, the light emitting element LE may be a micro light emitting diode.

The anode electrode of the light emitting element LE may be electrically connected to a source electrode a driving transistor DT and the cathode electrode of the light emitting element LE may be electrically connected to a second power line VSL to which a low-potential voltage lower than a high-potential voltage is supplied. In the circuit diagram shown in FIG. 17, a case where the anode electrode of the light emitting element LE is a pixel electrode (PXE shown in FIGS. 13 to 16), and the cathode electrode of the light emitting element LE is a common electrode (CE shown in FIGS. 13 to 16) is exemplified.

The driving transistor DT may control a current flowing from a first power line VDL to which a first power voltage is applied to the light emitting element LE according to a voltage difference between a gate electrode and the source electrode thereof. The gate electrode of the driving transistor DT may be electrically connected to a first electrode of a first transistor ST1, the source electrode of the driving transistor DT may be electrically connected to the anode electrode of the light emitting element LE, and a drain electrode of the driving transistor DT may be electrically connected to the first power line VDL to which a high-potential voltage is applied.

The first transistor ST1 may be turned on by a scan signal of a scan line SL to electrically connect a data line DL to the gate electrode of the driving transistor DT. A gate electrode of the first transistor ST1 may be electrically connected to the scan line SL, the first electrode of the first transistor ST1 may be electrically connected to the gate electrode of the driving transistor DT, and a second electrode of the first transistor ST1 may be electrically connected to the data line DL.

A second transistor ST2 may be turned on by a sensing signal of a sensing signal line SSL to electrically connect an initialization voltage line VIL to the source electrode of the driving transistor DT. A gate electrode of the second transistor ST2 may be electrically connected to the sensing signal line SSL, a first electrode of the second transistor ST2 may be electrically connected to the initialization voltage line VIL, and a second electrode of the second transistor ST2 may be electrically connected to the source electrode of the driving transistor DT.

The first electrode of each of the first and second transistors ST1 and ST2 may be a source electrode, and the second electrode of each of the first and second transistors ST1 and ST2 may be a drain electrode. However, embodiments are not limited thereto. For example, the first electrode of each of the first and second transistors ST1 and ST2 may be the drain electrode, and the second electrode of each of the first and second transistors ST1 and ST2 may be the source electrode.

It is illustrated that the pixel circuit portion PXC includes three transistors such as the driving transistor DT and the first and second transistors ST1 and ST2. However, the embodiments are not limited thereto. For example, the pixel circuit portion PXC may be provided in a structure further including multiple transistors more three or less than three.

A capacitor Cst may be formed between the gate electrode and the source electrode of the driving transistor DT. The capacitor Cst may store a difference voltage between a gate voltage and a source voltage of the driving transistor DT.

As depicted in FIG. 17, a case where the driving transistor DT and the first and second transistors ST1 and ST2 are implemented with an NMOS transistors is exemplified. However, some or all of the transistors may be implemented with a PMOS transistor.

A display device according to an embodiment is applicable to various types of electronic devices. In an embodiment, an electronic device includes the above-described display device and may further include other modules or devices having additional functions in addition to the display device.

FIG. 18 is a block diagram of an electronic device according to an embodiment. Referring to FIG. 18, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

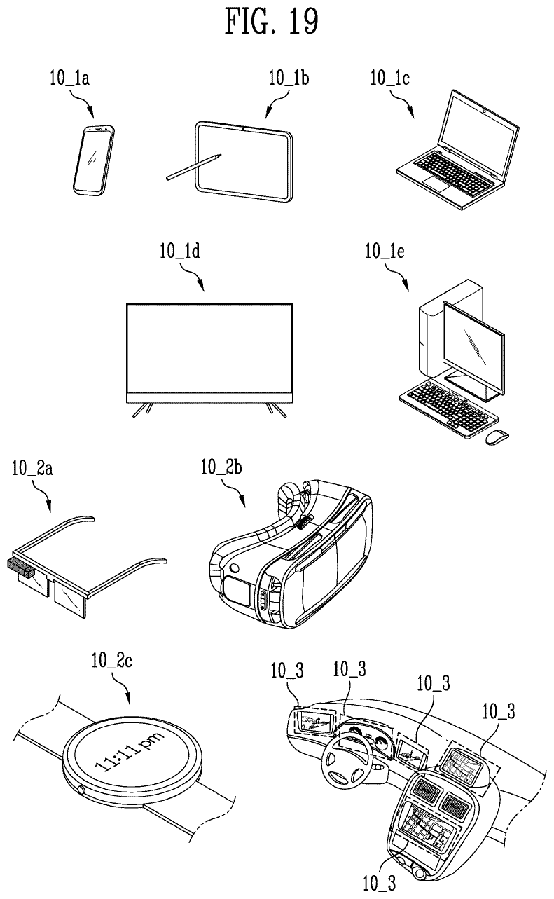

FIG. 19 shows schematic views of various embodiments of an electronic device.

Referring to FIG. 19, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

In accordance with the disclosure, display panels emitting lights having different wavelengths may be disposed to extend in the same direction, and optical lenses and dichroic mirrors may be respectively disposed in the display panels, so that heat generation and degradation of the display device can be reduced or prevented, and the weight and volume of the display device can be decreased.

Example embodiments have been disclosed herein, and although specific terms are employed, they are used and are to be interpreted in a generic and descriptive sense only and not for purpose of limitation. In some examples, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the disclosure as set forth in the following claims.

1. A display device comprising:
a first display panel emitting first light;
a second display panel emitting second light having a color different from a color of the first light;
a third display panel emitting third light having a color different from the colors of the first and second lights;
a first optical lens disposed on the first display panel to collimate the first light into first collimated light;
a second optical lens disposed on the second display panel to collimate the second light into second collimated light;
a third optical lens disposed on the third display panel to collimate the third light into third collimated light;
a first dichroic mirror disposed on an optical path of the first collimated light, to reflect the first collimated light as first reflected light;
a second dichroic mirror disposed on an optical path of the first reflected light and an optical path of the second collimated light, to allow the first reflected light to be transmitted as (1_1)st transmitted light therethrough and reflect the second collimated light as second reflected light; and
a third dichroic mirror disposed on an optical path of the (1_1)st transmitted light, an optical path of the second reflected light, and an optical path of the third collimated light, to allow the (1_1)st transmitted light to be transmitted as (1_2)nd transmitted light therethrough, allow the second reflected light to be transmitted as second transmitted light therethrough, and reflect the third collimated light as third reflected light.

2. The display device of claim 1, wherein the first to third display panels substantially extend in a same direction.

3. The display device of claim 1, wherein the first light is emitted in a first emission direction from the first display panel,
the second light is emitted in a second emission direction from the second display panel, and
the third light is emitted in a third emission direction from the third display panel, and
the first to third emission directions are substantially a same direction.

4. The display device of claim 1, wherein the first light is emitted through a first emission path from the first display panel,
the second light is emitted through a second emission path from the second display panel, and
the third light is emitted through a third emission path from the third display panel, and
the first to third emission paths are parallel to one another.

5. The display device of claim 4, wherein the (1_2)nd transmitted light, the second transmitted light, and the third reflected light are combined as output light to be viewed by a user, and
a fourth emission path of the output light intersects each of the first to third emission paths.

6. The display device of claim 1, wherein each of the first to third optical lenses is a meta-lens.

7. The display device of claim 1, further comprising:
a first circuit portion on which the first display panel is disposed;
a second circuit portion on which the second display panel is disposed; and
a third circuit portion on which the third display panel is disposed,
wherein the first to third circuit portions substantially extend in a same direction.

8. The display device of claim 7, wherein a first thickness of the first circuit portion, a second thickness of the second circuit portion, and a third thickness of the third circuit portion are different from one another.

9. The display device of claim 8, wherein the first thickness is thicker than the second thickness, and
the second thickness is thicker than the third thickness.

10. The display device of claim 7, further comprising:
a first circuit board layer overlapping the first to third circuit portions;
a second circuit board layer overlapping the first and second circuit portions; and
a third circuit board layer overlapping the first circuit portion.

11. The display device of claim 10, wherein the first circuit board layer, the second circuit board layer, and the third circuit board layer are sequentially stacked.

12. The display device of claim 10, wherein the second circuit board layer is exposed without being covered by the third circuit board layer in the second circuit portion, and
the first circuit board layer is exposed without being covered by the second and third circuit board layers in the third circuit portion.

13. The display device of claim 12, wherein the first circuit board layer overlaps the third display panel in an area in which the first circuit board layer is exposed without being covered by the second and third circuit board layers, and
the second circuit board layer overlaps the second display panel in an area in which the second circuit board layer is exposed without being covered by the third circuit board layer.

14. The display device of claim 10, wherein the first display panel is disposed on the third circuit board layer,
the second display panel is disposed on the second circuit board layer, and
the third display panel is disposed on the first circuit board layer.

15. The display device of claim 10, wherein the first circuit board layer includes a first base layer, a first conductive layer which is disposed on the first base layer and includes a plurality of first conductive lines connected to the third display panel, and a first insulating layer disposed on the first conductive layer,
the second circuit board layer includes a second base layer disposed on the first insulating layer, a second conductive layer which is disposed on the second base layer and includes a plurality of second conductive lines electrically connected to the second display panel, and a second insulating layer disposed on the second conductive layer, and
the third circuit board layer includes a third base layer disposed on the second insulating layer, a third conductive layer which is disposed on the third base layer and includes a plurality of third conductive lines electrically connected to the first display panel, and a third insulating layer disposed on the third conductive layer.

16. The display device of claim 15, wherein the first display panel includes a first pad portion electrically connected to the plurality of third conductive lines,
the second display panel includes a second pad portion electrically connected to the plurality of second conductive lines, and
the third display panel includes a third pad portion electrically connected to the plurality of first conductive lines.

17. The display device of claim 15, wherein the first circuit portion includes a first circuit pad portion electrically connected to the plurality of third conductive lines,
the second circuit portion includes a second circuit pad portion electrically connected to the plurality of second conductive lines, and
the third circuit portion includes a third circuit pad portion electrically connected to the plurality of first conductive lines.

18. The display device of claim 15, further comprising a fourth circuit portion extending from any one of the first to third circuit portions, the fourth circuit portion not overlapping the first to third display panels.

19. The display device of claim 18, wherein the fourth circuit portion includes:
a first via hole sequentially penetrating the third insulating layer, the third conductive layer, the third base layer, the second insulating layer, the second conductive layer, the second base layer, and the first insulating layer;
a second via hole sequentially penetrating the third insulating layer, the third conductive layer, and the third base layer, and the second insulating layer; and
a third via hole penetrating the third insulating layer.

20. An electronic device comprising:
a processor; and
a display device including pixels, and configured to display images on the pixels under control of the processor,
wherein a display device includes:
a first display panel emitting first light;
a second display panel emitting second light having a color different from a color of the first light;
a third display panel emitting third light having a color different from the colors of the first and second lights;
a first optical lens disposed on the first display panel to collimate the first light into first collimated light;
a second optical lens disposed on the second display panel to collimate the second light into second collimated light;
a third optical lens disposed on the third display panel to collimate the third light into third collimated light;
a first dichroic mirror disposed on an optical path of the first collimated light, to reflect the first collimated light as first reflected light;
a second dichroic mirror disposed on the optical path of the first collimated light and an optical path of the second collimated light, to allow the first reflected light to be transmitted as (1_1)st transmitted light therethrough and reflect the second collimated light as second reflected light; and
a third dichroic mirror disposed on the optical path of the (1_1)st transmitted light, an optical path of the second reflected light, and an optical path of the third collimated light, to allow the (1_1)st transmitted light to be transmitted as (1_2)nd transmitted light therethrough, allow the second reflected light to be transmitted as second transmitted light therethrough, and reflect the third collimated light as third reflected light.
